(19) United States
(12) Patent Application Publication
(10) Pub. No.: US 2009/0077359 A1
(43) Pub. Date: Mar. 19, 2009

(54) ARCHITECTURE RE-UTILIZING COMPUTATIONAL BLOCKS FOR PROCESSING OF HETEROGENEOUS DATA STREAMS

(76) Inventors: Hari Chakravarthula, San Jose, CA (US); Christopher J. Loo, Santa Clara, CA (US); Jose Mendez, San Jose, CA (US)

Correspondence Address: HICKMAN PALERMO TRUONG & BECKER / TESSERA INC., 2055 GATEWAY PLACE , SUITE 550, SAN JOSE, CA, 95110-1083, US

(21) Appl. No.: 11/945,743

(22) Filed: Nov. 27, 2007

Related U.S. Application Data
(60) Provisional application No. 60/973,446, filed on Sep. 18, 2007.

(51) Int. Cl. G06F 9/30

(52) U.S. Cl. 712/229; 712/E09.016

(57) ABSTRACT

An architecture for heterogeneous data processing which reuses the same hardware to process different data in different manners is disclosed. The different processing has a substantial similarity; such as performing different variations of a computation. For example, the computation may involve the same mathematical operations but use different constants or coefficients, or performing similar arithmetic operations that can be switched such as addition and subtraction, or performing arithmetic operations in different orders, etc. The different processing might be applying different convolution kernels depending on the pixel color. The differences between the kernels could include different kernel sizes, different coefficient locations, and different coefficient values. The same hardware is re-used for all of the similar computations, under the control of external control logic that allows hardware re-use.

### PRIORITY CLAIM

This application claims benefit under 35 U.S.C. §119(e) of Provisional Appln. 60/973,446, filed Sep. 18, 2007, the entire contents of which is hereby incorporated by reference as if fully set forth herein.

### CROSS-REFERENCE TO RELATED APPLICATIONS

This application is related to U.S. patent application Ser. No. 11/939,456 entitled “EFFICIENT IMPLEMENTATIONS OF KERNEL COMPUTATIONS”, filed Nov. 13, 2007, the entire contents of which is hereby incorporated by reference as if fully set forth herein.

This application is related to U.S. patent application Ser. No. ______, (Attorney Docket Number 60166-0014) entitled “TECHNIQUES FOR ADJUSTING THE EFFECT OF APPLYING KERNELS TO SIGNALS TO ACHIEVE DESIRED EFFECT ON SIGNAL”, filed ______, the entire contents of which is hereby incorporated by reference as if fully set forth herein.

### BACKGROUND

Programmable electronic devices that can be used to implement a multitude of designs are known. One example is a field-programmable gate array (FPGA), which is a semiconductor containing programmable logic components called “logic blocks” and programmable interconnects. The logic blocks can be programmed to function as basic logic gates such as AND, NOR, XOR, etc. More complex functions such as decoders can also be programmed. The logic blocks and interconnects can be programmed “in the field,” after the device is manufactured. Thus, the customer can program the FPGA to implement any one of countless designs.

While FPGAs have great flexibility, a possible drawback is that they tend to operate more slowly than devices that are dedicated to a specific purpose, such as an application specific integrated circuit (ASIC). Moreover, for a typical application, much of an FPGA may be un-used. Thus, if keeping gate count low is important, a FPGA type of design may not be desirable.

Another type of programmable device is a programmable system on a chip (PSoC), which may contain different hardware blocks that can each be programmed to achieve some complex functionality. A PSoC may have a set of “analog blocks” that each can be programmed to implement functions such as an amplifier, an analog-to-digital converter, a digital to analog converter, or a filter. The PSoC might also have a set of “digital blocks,” which each can be programmed to implement functions such as a pulse width modulator, a timer, or a counter. By programming different blocks to each implement a separate functionality and programming the connections between the blocks, the PSoC can be used to implement a multitude of different systems.

However, each PSoC block needs to be quite complex in order to provide the aforementioned flexibility. Moreover, while having tremendous flexibility, a PSoC type of design is difficult to design, test, and debug. Furthermore, many of the resources on a PSoC go un-used in a typical application. Thus, if keeping gate count low is an important design consideration, then a PSoC type of design may be inappropriate. Moreover, typically PSoCs are programmed when they are powered on based on instructions stored in persistent memory. While the programming can be changed by altering the stored instructions, altering the programming requires re-booting the PSoC.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts an example ISP chain, in accordance with an embodiment;

FIG. 2 depicts a system architecture in accordance with an embodiment;

FIG. 3 depicts a portion of a pixel grid of a typical CMOS image sensor;

FIG. 4 depicts coefficient locations for example green, red and blue kernel matrices;

FIG. 5 depicts an example architecture having a control mechanism to control the type of processed performed by a computational block, in accordance with an embodiment;

FIG. 6 depicts an example architecture that performs processing of pixels of all colors in a single computational block, in accordance with an embodiment;

FIG. 7 depicts details of a FSM and control mechanism, in accordance with one embodiment;

FIG. 8 depicts several example kernel matrices in which the coefficients are radially symmetric, in accordance with an embodiment;

FIG. 9 depicts a kernel computational block, in accordance with an embodiment;

FIG. 10 depicts an example kernel multiplication block, in accordance with an embodiment;

FIG. 11 depicts data paths for a system level architecture, in accordance with an embodiment

FIG. 12 is a diagram of an example mobile device upon which embodiments of the present invention may be practiced; and

FIG. 13 is a diagram of an example computer system upon which embodiments of the present invention may be practiced.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

To implement systems that do not require great flexibility, but do require a low gate count, a simpler solution than devices such as FPGAs and PSoCs is desirable. The solution should use gate level resources efficiently and should be easy to design and verify. Moreover, the solution should allow different processing to be applied without re-booting the device.

An architecture for heterogeneous data processing is described hereafter. In one embodiment, the architecture reuses the same hardware to process different data in different ways. The different data could be different data streams, or different types of data within the same data stream. As an example, red, blue, and green pixel data could each have different processing applied thereto, by re-using the same hardware. Any number of different data streams or types can be processed.

In one embodiment, the different processing has a substantial similarity; such as performing different variations of a computation. For example, the computation may involve the same mathematical operations but use different constants or coefficients, or performing similar arithmetic operations that can be switched such as addition and subtraction, or performing arithmetic operations in different orders, etc. The different processing might be applying different convolution kernels depending on the pixel color. The differences between the kernels could include different kernel sizes, different coefficient locations, and different coefficient values.

The same hardware is re-used for all of the similar computations, under the control of external control logic that allows hardware re-use. In one embodiment, the hardware has a first interface that is operable to receive input data and a second interface that is operable to receive parameters. The hardware may be dedicated to perform a computation involving the input data and the parameters. A control mechanism determines which input type, of a plurality of possible input types, particular input data corresponds to. For example, the control mechanism analyzes one or more data streams to determine the type of processing that should be applied to a data stream or portion thereof. The control mechanism causes the hardware to perform the variation of the computation on the particular input data. Therefore, the control mechanism is configured to cause the hardware to re-use the same logic to apply different variations of the computation to different input data.

In one embodiment, the control mechanism provides appropriate coefficients or constants to the hardware to cause the desired variation in the computation. In an embodiment, the same hardware is able to perform convolution for the green, blue, and red matrices by appropriate coefficient inputs to the hardware even though a green kernel matrix might have coefficients in different locations from a red or a blue kernel matrix.

### Example Image Signal Processing Chain

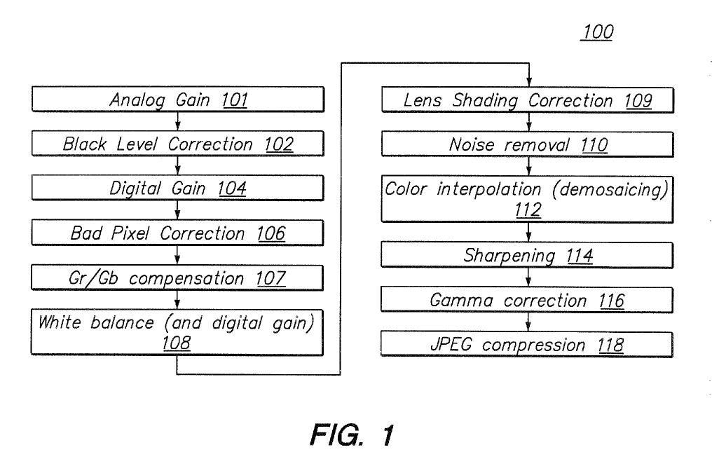

In digital still camera modules, the set of algorithms that process a raw image, and output a final image (e.g., JPEG image, TIFF image, etc.) that is saved in a non-volatile memory is called Image Signal Processing chain, or ISP chain. FIG. 1 depicts typical stages that are present in an ISP chain 100. An ISP chain could have other stages and is not required to have all of the stages that are depicted in FIG. 1. The stages could be in different order.

In an embodiment, an architecture for heterogeneous data processing resides within the sharpening stage 114. However, the architecture is not limited to residing in the sharpening stage 114 nor is the architecture limited to residing on an ISP chain 100. The architecture can be used for computations other than signal processing, in accordance with an embodiment.

In one embodiment, digital auto-focus (also referred to herein as “sharpening”) is implemented as a standalone stage that serves as a part of an ISP chain. The example ISP chain 100 shows a possible location for a sharpening stage 114, in accordance with an embodiment. However, the sharpening stage 114 could be located elsewhere in the example ISP chain 100. The example ISP chain 100 contains the following stages. The analog gain 101 applies gain before A/D conversion to compensate for dark image (e.g., while using low exposure time). The black level correction 102 removes a floor value from the image (i.e., “dark current” that is output from the sensor). The bad pixel correction 106 locates “burned” pixels that produce false very low or very high values in the image and replaces them with a “smart” average of the environment. The Gr/Gb compensation 107 compensates, in CMOS sensors that have a BAYER pattern, for differences that might occur between green pixels values in lines with blue pixels and green pixels values in lines with red pixels. It is not required that the image sensor use a BAYER format. The white balance (and digital gain) 108 applies gains on each color (Green-Red, Red, Green-Blue, Blue) in order to balance the colors and compensate for lighting conditions and light levels, while maintaining dynamic range. The lens shading correction 109 compensates for the lens shading profile by increasing the luminance of far-from-the-center pixels. The noise removal 110 removes random noise and fixed-pattern noise from the image. The color interpolation (demosaicing) 112 interpolates the BAYER image to a complete RGB image, in which every pixel has three color channel values. The sharpening 114 enhances the contrast in the image. The gamma correction 116 applies a gamma curve to the image. The JPEG compression 118 compresses the image from a full BMP image to a JPEG image that can then be saved to a non-volatile memory (such as flash memory). Compression other than JPEG could be used.

In one embodiment, sharpening is applied on bayer information; therefore, the sharpening stage 114 should come before any demosaicing 112 that might be performed. However, it is not required that the sharpening stage 114 comes before the demosaicing stage 112. In an embodiment, the sharpening stage 114 should come after the bad pixel correction stage 106 because the sharpening 114 may enhance the bad pixels effect. In an embodiment, it is recommended that the sharpening stage 114 be located after bayer-denoising 110, white balance 108, shading-correction 109, and after any other stage that corrects sensor faults.

In an embodiment of the algorithm, the camera module system that captured the image contains a macro/normal feature that enables the user to choose whether to take a close-object image (e.g., 20-40 cm) or to capture a distant-object image (e.g., 40 cm-infinity). The selection of the mode is input into the sharpening stage 114, in one embodiment, and may be used to change the processing. For example, different de-convolution kernels could be used, or the kernels could be altered, depending on the shooting mode. Other parameters from other stages in the ISP chain 100 can also be input to the sharpening stage 114. As one example, another stage provides the sharpening stage 114 with a S/N figure pertaining to the image. The sharpening stage 114 adjusts the amount of sharpening based on the S/N figure. In one embodiment, the amount of sharpening is based on pixel location, which may be provided by another stage in the ISP chain 100.

### Example System Architecture

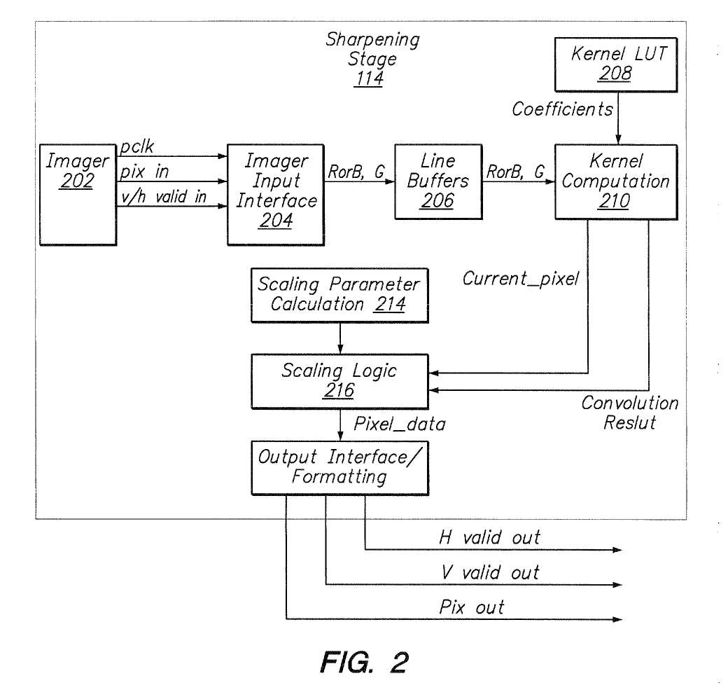

FIG. 2 depicts an overview of a system architecture in accordance with an embodiment. In one embodiment, the system of FIG. 2 is used for the sharpening stage 114 of FIG. 1. In general, the example system inputs pixel data from an image sensor and applies de-convolution kernels to the pixel data. The de-convolution kernels are used to sharpen the image in this embodiment. However, de-convolution kernels can be used for many other purposes. The system determines a new value for one pixel at a time by applying a selected kernel matrix to a signal matrix. The signal matrix includes the current pixel being updated and selected surrounding pixels. The current pixel is located in the center of the signal matrix, in an embodiment. In one embodiment, the pixels that form the signal matrix are all of the same color. However, the signal matrix can include values for pixels of different colors.

The function of the various elements in the system architecture will now be overviewed. The imager 202 outputs a pixel clock (pclk) and pixel data (pix_in) to the imager input interface 204. The imager 202 also outputs vertical and horizontal synchronization signals (v/h valid in). The imager input interface 204 and line buffers 206 store the input pixel data. The kernel LUT 208 feeds in different kernel coefficient values to the kernel computational stage 210. The kernel LUT 208, under control of control stage 504, outputs the correct kernel coefficients for the appropriate center pixel color. The control mechanism 504 determines appropriate processing that should be applied to the current pixel and selects appropriate kernel coefficients for that color pixel, in an embodiment.

The scaling parameter calculation 214 and determines “scaling parameters.” The scaling factors can be based on a signal-to-noise ratio, the relative position of the pixel in the image sensor, and statistics of pixel values around center pixel. The scaling logic 216 takes in the scaling parameters every clock cycle and uses the scaling parameters to create the final output.

As an example, the scaling examples could be referred to as “α” and “β.” IN one embodiment, the scaling logic computes the product “αβ” and the value “1−αβ,” which are used to create the final output for the pixel. In particular, the convolution result from the kernel computation is multiplied by αβ and added to the original value of the current pixel value multiplied by (1−αβ). This sum may be down shifted to normalize for alpha and beta giving the final recalculated current pixel value. Additional details of calculating example scaling parameters such as α and β are discussed below.

### Example CMOS Image Sensor

FIG. 3 depicts a portion of a pixel grid 300 of a typical CMOS image sensor. The pixel grid 300 is in raw Bayer format in which each pixel is a representation in which rows contain either red and green pixels or blue and green pixels. Several 13×13 kernel areas are depicted overlaying the pixel grid 300. Each kernel operation updates the value of the center pixel of the respective kernel area. Therefore, the kernel that is used for each area is based on the color of the center pixel. The entire CMOS image sensor could contain up to a million or even millions of pixels.

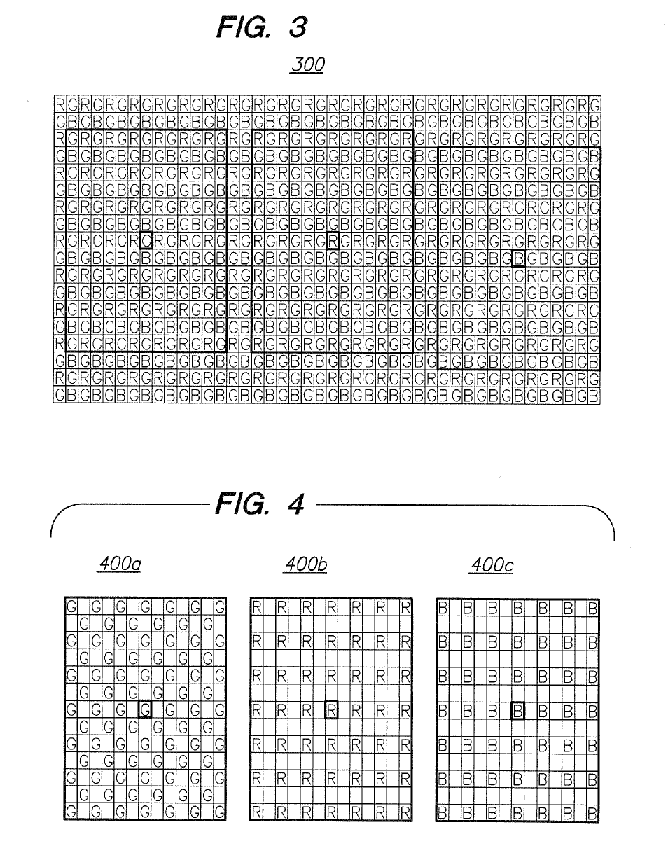

FIG. 4 depicts coefficient locations for example green 400a, red 400b and blue 400c kernel matrices. The coefficients are depicted as a letter (R/G/B) rather than the actual value for the coefficient. The red 400b and blue 400c kernel matrices each have a 7×7 pattern. However, the green kernel matrix 400a has the 7×7 pattern overlaid by a 6×6 pattern. Note that the patterns in FIG. 4 correspond to the pixel grid 300 of the image sensor FIG. 3. To apply the kernel to the image data, each kernel coefficient is multiplied by the value of the corresponding pixel in the region of the pixel grid 300 that is overlaid by the kernel (“kernel region”). Based on these multiplications, the center pixel in each kernel region is updated. For example, the multiplication products are summed together and the sum is used to replace the center pixel value.

### Architectural Overview

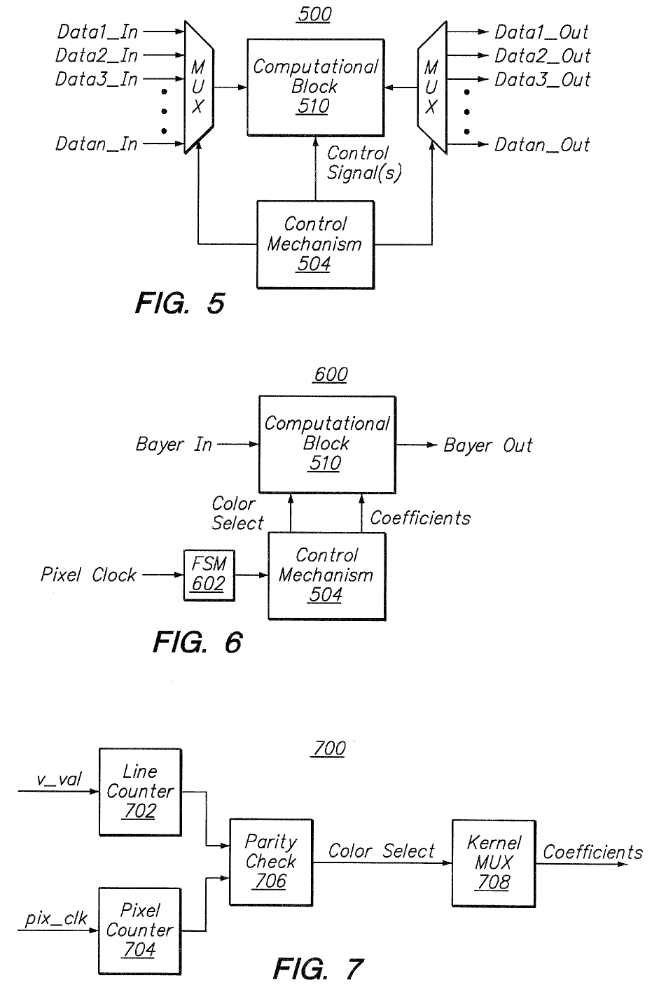

FIG. 5 depicts an example architecture having a control mechanism 504 to control the type of processed performed by a computational block 510, in accordance with an embodiment. The control mechanism 504 selects one of the “n” input data streams to be processed by the computational block 510. Moreover, the control mechanism 504 determines the type of processing that should be applied to the selected input data stream and provides one or more control signals to the computational block 510 to cause the computational block 510 to perform the appropriate processing to the selected input data stream. The computational block 510 outputs a computational result, which is multiplexed to one of the “n” data_outputs.

The control mechanism 504 determines the type of processing to be applied to the input data from among multiple types of processing. As an example, each data stream could correspond to pixel data for a different color pixel. Using this example, the control mechanism 504 determines the type of processing that is appropriate for each pixel color, and provides appropriate control signals to cause the computational block 510 to perform the appropriate processing based on what data stream is being input to the computational block 510. In one embodiment, the control signals to the computational block 510 are kernel coefficients. However, different control signals could be provided to the computational block 510.

The computational block 510 is dedicated to performing a computation, in one embodiment. As one example, the computational block 510 is dedicated to performing kernel multiplication between input data (Data_in) and kernel coefficients that are provided by the control mechanism 504. The control mechanism is able to cause the computational block 510 to perform different variations of the computation by providing the computational block 510 with appropriate control signals. As non-limiting examples, the variation in the computation could be kernel multiplication involving different size kernels, kernels having coefficients in different locations, or kernels having different coefficients in the same location.

Note that in some cases, the same processing might be applied to different data streams. For example, red and blue pixels might be processed in one manner, whereas green pixels are processed in a different manner. However, the data streams do not have to be pixel data. The example architecture 500 allows modular generation and verification of a single computational block 510, avoiding generation and verification of up to “n” different computational modules.

In one embodiment, the computational block control signals are input to a data input of the computational block 510. Thus, the computational block 510 does not need to be re-programmed by, for example, switching data paths within the computational block 510 in order to apply different processing to the data streams. Moreover, different processing can be applied to each data stream without re-booting the architecture 500. Thus, the different processing can be applied to each data stream in real time.

It is not required that the input data be provided in separate streams as depicted. In one embodiment, the data is provided in a single data stream. For example, the data stream could contain red, blue, and green pixel data from a CMOS sensor having a BAYER format. Based on the BAYER format, the appropriate pixel data can either be provided to the computational block 510, or the computational block 510 could extract the correct pixel data to process.

The example architecture allows for efficient design, verification, and testing. For example, the computational block 510 can be described in as a register transfer level (RTL) design, such that the same RTL design can be used for different types of processing. Moreover, when the computational block 510 is implemented as transistors and/or other semiconductor devices, the same semiconductor devices can be re-used for different types of processing (e.g., for variations in a computation such as kernel multiplication).

### Example in Which the Processing of Data is Convolution

The architecture 500 provides for real-time processing of pixel data received directly from an image sensor, in an embodiment. To compute the processed value of a given pixel, pixel values around the given pixel are multiplied by a set of kernel coefficients, and the results from these multiplications are then added to form a “convolution result.” In one embodiment, the convolution result is averaged in a weighted manner with the original center pixel, with the weights dependent on one or more “scaling factors.” The scaling factors can be based on a signal-to-noise ratio, the relative position of the pixel in the image sensor, and statistics of pixel values around center pixel. Additional details of determining scaling factors is described in U.S. patent application Ser. No. ______, Attorney docket number 60016-0014, which is hereby incorporated by reference for all purposes.

FIG. 6 depicts an embodiment of the present invention in which a computational block 510 performs processing of different color pixels that might otherwise be performed in separate computational blocks for each pixel. That is, the same hardware is used processing pixels of all colors. The finite state machine (FSM) 602 is used to determine which color pixel is currently being processed. The FSM 602 inputs a “pixel clock” to determine what color pixel is to be processed. Further details of the FSM 602 and pixel clock are discussed below.

Based on the color of the pixel to be processed, the control mechanism 504 outputs a “color select signal” to the computational block 510, in this embodiment. The color select signal may be used by the computational block 510 to select data for processing. The computational block 510 may select a data stream from multiple data streams or extract data from a single data stream.

The control mechanism 504 outputs appropriate coefficients to process the current input data. In one embodiment, the computational block 510 updates the value of a single pixel. In this example, the control mechanism 504 outputs kernel coefficients for a red kernel when a red pixel is being processed, kernel coefficients for a green kernel when processing a green pixel, etc. However, in addition to coefficients that are actually used in computation, the control mechanism 504 may output additional “null” coefficients. For example, referring to FIG. 4, the red kernel 400b has fewer coefficients than the green kernel 400a. Null coefficients are inserted into the even rows of the red kernel 400b at locations that correspond to the coefficients in the green kernel 400a, in an embodiment. The blue kernel coefficients may be augmented a similar manner as the red coefficients.

In this example, the pixel data input to the computational block is in BAYER format. However, the computational block 510 processes pixel data having a different format, in another embodiment.

### FSM and Control Mechanism in Accordance with an Embodiment

FIG. 7 depicts details of the FSM 602 and control mechanism 504, in accordance with one embodiment. The FSM 602 and control mechanism 504 include a pair of counters 702, 704 and parity check logic 706. The line counter 702 and pixel counter 704 each feed the parity check logic 706 which, depending on the parity of the current line and pixel count, determines which color of pixel is being processed. The line and pixel counters run off the pixel clock and v_val/v_sync signals provided directly by the imager (FIG. 1, 202). The Kernel MUX block 708 contains the corresponding kernel coefficients for each color, including nulls (e.g., zeros) inserted when the current color requires less than the maximum number of kernel coefficients for computation.

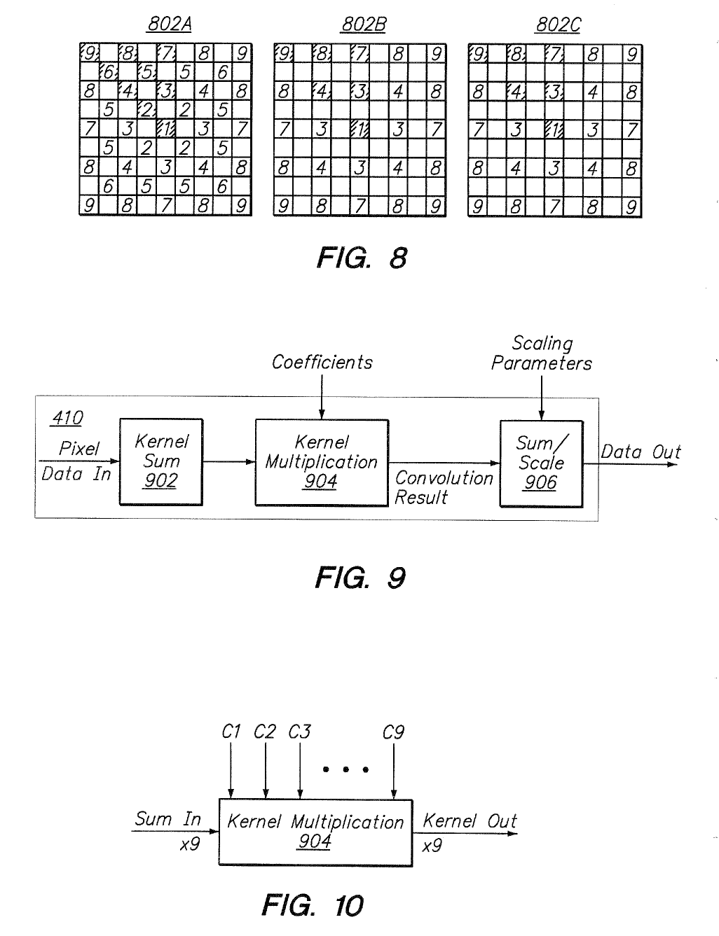

In one embodiment, the kernel coefficients that are supplied from the Kernel MUX 708 correspond to kernel matrices that have radially symmetric kernel coefficients. FIG. 8 depicts several example kernel matrices in which the coefficients are radially symmetric, in accordance with an embodiment. The three Bayer colors can be separated into separate 9×9 kernels used to process and update the center pixel. The pixel data (FIG. 3) is represented by the Green, Red, and Blue 9×9 matrices, in an embodiment. The values used to process these matrices are 9×9 kernels with unique weights assigned to each pixel with a different distance to the center pixel. These weights are multiplied to the corresponding 9×9 color matrix of pixel data to create values that are summed to be contributed to the updated center pixel value.

Since the computation kernels are radially symmetric in this example, the number of computations can be drastically reduced by summing all equidistant pixel data and then multiplying once by each radial distance. When using the kernels depicted in FIG. 8, the red kernel 802b and blue kernel 802c have six unique kernel coefficients, while the green kernel 802a has nine unique kernel coefficients. Note that the red 802b and blue 802c kernels only have coefficients in every other row. The values in each kernel 802 in FIG. 8 indicate coefficients that have the same value in that kernel. For example, all coefficients represented by a “7” in the green kernel 802a have the same value. However, the coefficients represented by a “7” in the other kernels 802b, 802c may have values that are different from the green kernel 802a.

Rather than outputting a value for each coefficient, the kernel MUX 708 only outputs as many values as are required for the kernel with the most unique kernel coefficients, in an embodiment. In this example, the kernel MUX 708 outputs nine coefficients regardless of the color of the current pixel. The coefficients are provided to an interface of the computational block 510 that is configured to receive coefficients, in an embodiment. For example, referring briefly to FIG. 10, coefficients C1-C9 are provided to the kernel multiplication block 904. If the current pixel is red or blue, then the kernel MUX outputs “null” coefficients in appropriate locations when processing red or blue pixels. Thus, in this example, the kernel MUX 708 outputs a null value for locations in the red and blue kernels 802b, 802c that correspond to locations identified by “2,” “5,” and “6” in the green kernel 802a. The kernel computational block, which is discussed below, is configured such that only the unique coefficient values need to be provided to it.

Note that in this example each kernel matrix 802 has the same type of symmetry, wherein each set of coefficients that share a common value are positioned in the same locations in each kernel. The symmetry simplifies the logic that is used to perform kernel computations. However, it is not required that each kernel have the same symmetry.

### Example Kernel Computational Block

FIG. 9 depicts a kernel computational block 410, in accordance with an embodiment. In the embodiment depicted in FIG. 9, the kernel computational block 410 contains a kernel sum 902, which adds all pixel values which share the same kernel coefficients; a kernel multiplication block 904, which multiplies the different kernel sums by the corresponding kernel coefficients; and a sum and scale block 906, which adds and scales the results from the kernel multiplication procedure.

Using the kernel matrices of FIG. 8 as an example, the kernel sum block 902 would form nine pixel sums. For example, the pixel values that corresponds to the location of the “9” are summed together to form one of the pixel sums. Similar pixel sums are formed for pixels in locations 1 through 8. These nine pixel sums are provided to the kernel multiplication block 904, which multiplies each pixel sum by the coefficient whose location(s) in the kernel corresponds to the pixel locations used to create the pixel sum. For example, pixel sum created from pixel values at the location of the “9” are multiplied by the ninth coefficient. The kernel multiplication block 904 outputs a convolution result.

The sum/scaling logic 906 scales the convolution result based on the scaling parameters. Example scaling parameters such as α and β are discussed herein below. In one embodiment, the scaling logic 906 performs the following:

FinalRsult=ConvRs·Scalingproduct+(1−Scalingproduct)·InputPixel Eq: 1

In Equation 1, ConvRs is the convolution result from kernel multiplication block 904, Scalingproduct is the product of whatever scaling parameters are being used, and InputPixel is the value of the current pixel being processed.

### Example Kernel Multiplication Block

The computational block 410 of FIG. 9 is able to process pixels of all colors, in an embodiment. FIG. 10 depicts an embodiment in accordance with the present invention, in which the kernel multiplication block 904 is constructed as to use the maximum number of kernel sums and coefficients that might be required for whatever data types are being processed (e.g., red, blue, green pixels). In the example based on the kernels in FIG. 8, the greatest number of coefficients that might be needed is for the green kernel.

All sums are calculated independently of the current color value, but zeros are inserted by the control mechanism 402 at the kernel coefficient positions which correspond to unwanted computations. Thus, single multiplication block 904 in the embodiment of FIG. 10 is able to perform kernel computations for kernels having different numbers coefficients.

### Data Paths for an Example System Level Architecture

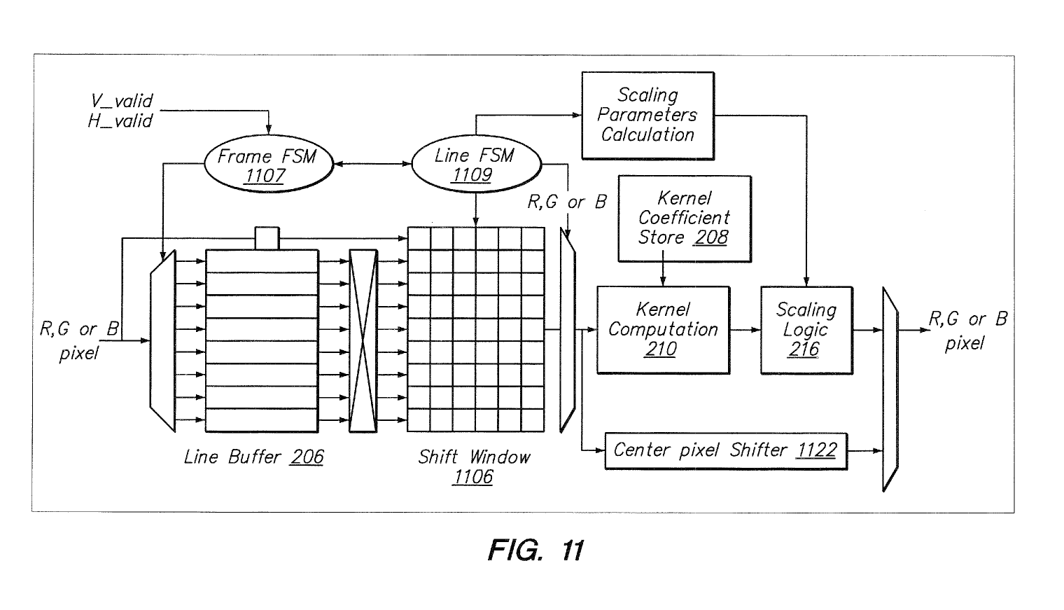

FIG. 11 depicts data paths for an example system level architecture, in accordance with an embodiment. The kernel coefficient block stores the coefficients for red, blue and green pixels and provides them to the kernel computational block. Details of a kernel computational block 210 have been previously discussed. Examples of calculating scaling parameters, such as α calculation, β calculation, and αβ scaling were previously discussed. However, the embodiment of FIG. 11 is not limited to those examples.

The Frame Control state machine 1107 (Frame FSM) manages the line buffer rotation, replacement as well as frame boundary. The line control state machine 1109 (Line FSM) controls the window shifting and padding for each line. The line FSM 1109 also manages the kernel coefficient lookup. The Frame FSM 1107 tracks the vertical position within the image, while the Line FSM 1109 tracks the horizontal position.

An embodiment of the present invention uses nine lines of the input image. Eight of these lines are from the line buffer 206, with one line coming in real-time. As examples, the line buffer 206 can be eight one-port 1036×2 pixels memory elements or a single one-port 1036×16 pixels with line enable. One pixel/color is processed per clock, in an embodiment. The use of the kernel computation 210 is shared among all three colors.

The center pixel shifter 1122 may be a parameterizable shifter that matches the pipeline stages of the calculation. The center pixel shifter 1122 may be used to delay the original pixel data to match the arithmetic pipeline. The path through the center pixel shifter 1122 may be used for final pixel out calculation, as well as for bypassing.

### Example Scaling Parameters

The following is a discussion of example techniques to calculate scaling parameters. The scaling parameters can be based on factors including, but not limited to, a signal-to-noise ratio of the signal data, properties of a device (e.g., lens) used to capture the signal data, spatial-dependent information (e.g., pixel location), or a metric that is derived based on an analysis of the signal data (e.g., pixels in the neighborhood of the pixel currently being processed).

As a non-limiting example, a parameter “alpha” can be based on a Signal to Noise Ratio (S/R) of the signal being processed. The S/R can be obtained from the image sensor as a new value every frame or controlled from external dip switches. In one embodiment, where a noise level estimator is a number between 0 and 7, the value of α is calculated using Equation 2.

α=(7−noise_val)/7 Equation (2)

Equation 2 indicates that the noisier the image is (the larger noise_val is), the lower is the value of α (and vice versa). Therefore, if there is little noise in the image, the value of α is close to 1.

As another non-limiting example, a parameter “beta” can be based on spatial-dependent information. For example, beta is calculated as follows, in an embodiment:

β=1−a·(R/(b·max(R)))² Equation 3:

In Equation 3, β has a value between 0 and 1. Each pixel is thus processed in accordance with its distance (R) from the lens center of the image. This distance or square distance can be calculated according to the following equations:

R=\sqrt{x_index²+y_index²} Equation 4:

R²=x_index²+y_index² Equation 5:

In equations 4 and 5, x_index and y_index are the indices of the pixel in the image (x for columns and y for rows), while the center pixel in the image is indexed [0, 0]. The values of “a” and “b” in Equation 3 are constants that impact the amount of shading. The values for “a” and “b” may change and may be provided by stages of the ISP chain prior to the sharpening stage 114. Additional details for determining scaling parameters are described in U.S. patent application Ser. No. ______ entitled ______ (Attorney Docket Number 60166-0014).

### Hardware Overview

### Example Mobile Device

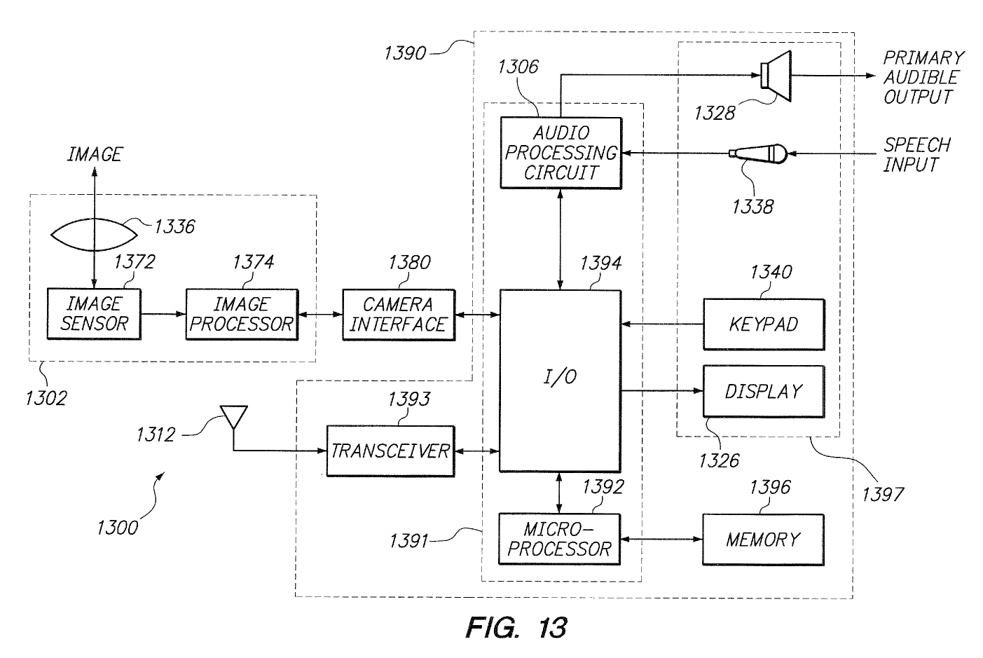

FIG. 13 illustrates a block diagram for an example mobile device 1300 in which embodiments of the present invention may be implemented. Mobile device 1300 comprises a camera assembly 1302, camera and graphics interface 1380, and a communication circuit 1390. Camera assembly 1370 includes camera lens 1336, image sensor 1372, and image processor 1374. Camera lens 1336, comprising a single lens or a plurality of lenses, collects and focuses light onto image sensor 1372. Image sensor 1372 captures images formed by light collected and focused by camera lens 1336. Image sensor 1372 may be any conventional image sensor 1372, such as a charge-coupled device (CCD) or a complementary metal oxide semiconductor (CMOS) image sensor. Image processor 1374 processes raw image data captured by image sensor 1372 for subsequent storage in memory 1396, output to a display 1326, and/or for transmission by communication circuit 1390. The image processor 1374 may be a conventional digital signal processor programmed to process image data, which is well known in the art.

Image processor 1374 interfaces with communication circuit 1390 via camera and graphics interface 1380. Communication circuit 1390 comprises antenna 1312, transceiver 1393, memory 1396, microprocessor 1392, input/output circuit 1394, audio processing circuit 1306, and user interface 1397. Transceiver 1393 is coupled to antenna 1312 for receiving and transmitting signals. Transceiver 1393 is a fully functional cellular radio transceiver, which may operate according to any known standard, including the standards known generally as the Global System for Mobile Communications (GSM), TIA/EIA-136, cdmaOne, cdma2000, UMTS, and Wideband CDMA.

The image processor 1374 may process images acquired by the sensor 1372 using one or more embodiments described herein. The image processor 1374 can be implemented in hardware, software, or some combination of software and hardware. For example, the image processor 1374 could be implemented as part of an application specific integrated circuit (ASIC). As another example, the image processor 1374 may be capable of accessing instructions that are stored on a computer readable medium and executing those instructions on a processor, in order to implement one or more embodiments of the present invention.

Microprocessor 1392 controls the operation of mobile device 1300, including transceiver 1393, according to programs stored in memory 1396. Microprocessor 1392 may further execute portions or the entirety of the image processing embodiments disclosed herein. Processing functions may be implemented in a single microprocessor, or in multiple microprocessors. Suitable microprocessors may include, for example, both general purpose and special purpose microprocessors and digital signal processors. Memory 1396 represents the entire hierarchy of memory in a mobile communication device, and may include both random access memory (RAM) and read-only memory (ROM). Computer program instructions and data required for operation are stored in non-volatile memory, such as EPROM, EEPROM, and/or flash memory, which may be implemented as discrete devices, stacked devices, or integrated with microprocessor 1392.

Input/output circuit 1394 interfaces microprocessor 1392 with image processor 1374 of camera assembly 1370 via camera and graphics interface 1380. Camera and graphics interface 1380 may also interface image processor 1374 with user interface 1397 according to any method known in the art. In addition, input/output circuit 1394 interfaces microprocessor 1392, transceiver 1393, audio processing circuit 1306, and user interface 1397 of communication circuit 1390. User interface 1397 includes a display 1326, speaker 1328, microphone 1338, and keypad 1340. Display 1326, disposed on the back of display section, allows the operator to see dialed digits, images, called status, menu options, and other service information. Keypad 1340 includes an alphanumeric keypad and may optionally include a navigation control, such as joystick control (not shown) as is well known in the art. Further, keypad 1340 may comprise a full QWERTY keyboard, such as those used with palmtop computers or smart phones. Keypad 1340 allows the operator to dial numbers, enter commands, and select options.

Microphone 1338 converts the user's speech into electrical audio signals. Audio processing circuit 1306 accepts the analog audio inputs from microphone 1338, processes these signals, and provides the processed signals to transceiver 1393 via input/output 1394. Audio signals received by transceiver 1393 are processed by audio processing circuit 1306. The basic analog output signals produced by processed audio processing circuit 1306 are provided to speaker 1328. Speaker 1328 then converts the analog audio signals into audible signals that can be heard by the user.

Those skilled in the art will appreciate that one or more elements shown in FIG. 13 may be combined. For example, while the camera and graphics interface 1380 is shown as a separated component in FIG. 13, it will be understood that camera and graphics interface 1380 may be incorporated with input/output circuit 1394. Further, microprocessor 1392, input/output circuit 1394, audio processing circuit 1306, image processor 1374, and/or memory 1396 may be incorporated into a specially designed application-specific integrated circuit (ASIC) 1391.

### Example Computer System

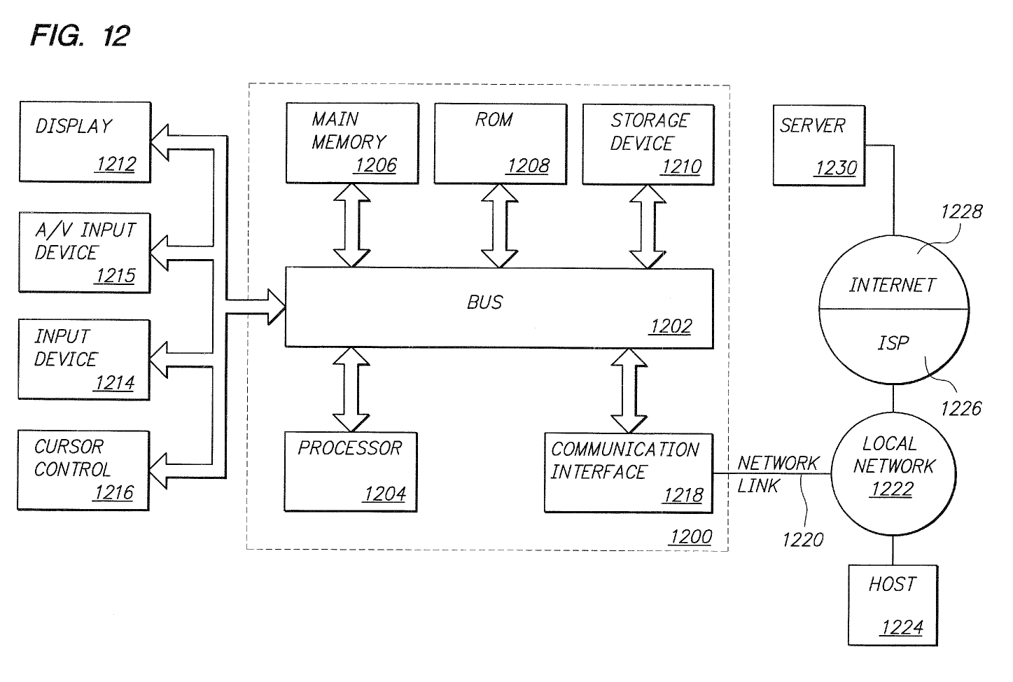

FIG. 12 is a block diagram that illustrates a computer system 1200 upon which an embodiment of the invention may be implemented. Computer system 1200 includes a bus 1202 or other communication mechanism for communicating information, and a processor 1204 coupled with bus 1202 for processing information. Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. The computer system 1200 may further include an audio/video input device 1215 such as a microphone or camera to supply audible sounds, still images, or motion video, any of which may be processed using the embodiments described above.

Various processing techniques disclosed herein may be implemented to process data on a computer system 1200. According to one embodiment of the invention, those techniques are performed by computer system 1200 in response to processor 1204 executing one or more sequences of one or more instructions contained in main memory 1206. Such instructions may be read into main memory 1206 from another machine-readable medium, such as storage device 1210. Execution of the sequences of instructions contained in main memory 1206 causes processor 1204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1200, various machine-readable media are involved, for example, in providing instructions to processor 1204 for execution. Such a medium may take many forms, including but not limited to storage media and transmission media. Storage media includes both non-volatile media and volatile media. Non-volatile media includes, for example, optical or magnetic disks, such as storage device 1210. Volatile media includes dynamic memory, such as main memory 1206. Transmission media includes coaxial cables, copper wire and fiber optics, including the wires that comprise bus 1202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1204 for execution. For example, the instructions may initially be carried on a magnetic disk of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are exemplary forms of carrier waves transporting the information.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution. In this manner, computer system 1200 may obtain application code in the form of a carrier wave.

Data that is processed by the embodiments of program code as described herein may be obtained from a variety of sources, including but not limited to an A/V input device 1215, storage device 1210, and communication interface 1218.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A device comprising:
hardware having:
a first interface that is operable to receive input data; and
a second interface that is operable to receive parameters;
wherein the hardware is dedicated to perform a computation involving the input data and the parameters; and
a control mechanism coupled to the hardware and configured to:
determine which input type, of a plurality of possible input types, particular input data corresponds to;
based on the determined input type, determine a variation of the particular computation; and
cause the hardware to perform the variation of the computation on the particular input data, wherein the control mechanism is configured to cause the hardware to re-use the same logic to apply different variations of the computation to different input data.

2. The device of claim 1, wherein the control mechanism, to cause the hardware to perform the variation of the computation on the particular input data, is configured to provide appropriate parameters to the second interface.

3. The device of claim 2, wherein the parameters are kernel coefficients.

4. The device of claim 1, wherein the particular computation is kernel multiplication and the control mechanism is configured to cause the hardware to re-use the same logic to perform kernel multiplication with different size kernel matrices.

5. The device of claim 1, wherein:
the hardware is configured to perform kernel multiplication involving “n” unique kernel coefficients that are received as parameters at the second interface; and
the control mechanism is configured to provide, at the second interface, a set of “n” kernel coefficients that includes at least one null coefficient.

6. The device of claim 1, wherein the hardware comprises a set of transistors that are re-used to perform the variations of the computations to different types of input data.

7. The device of claim 1, wherein:
the input data is pixel data, the computation is kernel multiplication; and
to perform the kernel multiplication, the hardware is configured to:
multiply the kernel coefficients and selected pixels of the pixel data to generate a kernel multiplication result; and
update a value for a particular pixel of the selected pixels, based on the kernel multiplication result.

8. The device of claim 7, wherein the hardware has scaling logic that is operable to scale the kernel multiplication result based on one or more scaling parameters.

9. The device of claim 1, wherein the hardware has summing logic that is operable to add values in the input data that correspond to kernel coefficients that have the same value.

10. The device of claim 1, wherein, by providing the hardware with appropriate kernel coefficients at the second interface, the control mechanism is configured to cause the hardware to perform kernel multiplication with kernels that have different configurations of coefficients from each other.

11. A camera comprising:
an image sensor; and
pixel processing logic, wherein the pixel processing logic comprises:
an interface that is configured to receive pixel data from the image sensor;
hardware having:
a first interface that is operable to receive the pixel data; and
a second interface that is operable to receive parameters;
wherein the hardware is dedicated to perform a computation involving the pixel data and the parameters; and
a control mechanism coupled to the hardware and configured to:
determine which input type, of a plurality of possible input types, particular pixel data corresponds to;
based on the determined input type, determine a variation of the particular computation; and
cause the hardware to perform the variation of the computation on the particular pixel data, wherein the control mechanism is configured to cause the hardware to re-use the same logic to apply different variations of the computation to different pixel data.

12. The camera of claim 11, wherein the control mechanism, to cause the hardware to perform the variation of the computation on the particular pixel data, is configured to provide appropriate parameters to the second interface.

13. The camera of claim 12, wherein the parameters are kernel coefficients.

14. The camera of claim 11, wherein the particular computation is kernel multiplication and the control mechanism is configured to cause the hardware to re-use the same logic to perform kernel multiplication with different size kernel matrices.

15. The camera of claim 11, wherein:
the hardware is configured to perform kernel multiplication involving “n” unique kernel coefficients that are received as parameters at the second interface; and
the control mechanism is configured to provide, at the second interface, a set of “n” kernel coefficients that includes at least one null coefficient.

16. The camera of claim 11, wherein the hardware comprises a set of transistors that are re-used to perform the variations of the computations to different types of pixel data.

17. The camera of claim 11, wherein:
the computation is kernel multiplication; and
to perform the kernel multiplication, the hardware is configured to:
multiply the kernel coefficients and selected pixels of the pixel data to generate a kernel multiplication result; and
update a value for a particular pixel of the selected pixels, based on the kernel multiplication result.

18. The camera of claim 17, wherein the hardware has scaling logic that is operable to scale the kernel multiplication result based on one or more scaling parameters.

19. The camera of claim 11, wherein the hardware has summing logic that is operable to add values in the pixel data that correspond to kernel coefficients that have the same value.

20. The camera of claim 11, wherein, by providing the hardware with appropriate kernel coefficients at the second interface, the control mechanism is configured to cause the hardware to perform kernel multiplication with kernels that have different configurations of coefficients from each other.
